(19) United States
(12) Patent Application Publication
(10) Pub. No.: US 2025/0304192 A1
(43) Pub. Date: Oct. 2, 2025

(54) VEHICLE HAVING AN ACTIVE LENGTH AND ANGLE REAR DIFFUSER

(71) Applicant: FCA US LLC, Auburn Hills, MI (US)

(72) Inventors: Mark J Skynar, Farmington Hills, MI (US); Samarasingham Jeyasingham, Sterling Heights, MI (US); Arturo Guzman-Magana, LaSalle (CA); Fabian Heinz Dieter Krissel, Rostock (DE)

(21) Appl. No.: 18/619,319

(22) Filed: Mar. 28, 2024

(51) Int. Cl. B62D 35/00

(52) U.S. Cl. CPC B62D 35/007

(57) ABSTRACT

A diffuser that can be used on a plurality of different vehicles having different aerodynamic properties. The diffuser includes a diffuser assembly controller including a memory. Instructions corresponding to a plurality of deployed positions of the diffuser for each of the different vehicles are stored in the memory, and can be accessed by the diffuser assembly controller based on a signal received from a vehicle electronic control unit (ECU) that identifies the model of the vehicle. After receiving the signal from the ECU, the diffuser assembly controller can actuate the diffuser to the correct deployed positions associated with the model of the vehicle.

### FIELD

The present disclosure relates to a vehicle having an active length and angle rear diffuser.

### BACKGROUND

This section provides background information related to the present disclosure which is not necessarily prior art.

Diffusers may be provided on vehicles to improve the aerodynamic properties of the vehicle, which in turn may increase the vehicle's gas mileage or its electric range. Conventional diffusers are solid members that may be expensive to manufacture because each time a new vehicle is designed, the diffuser must also be designed relative to the new vehicle. For example, a new mold for the diffuser must be separately designed and manufactured to produce the diffuser. Further, because diffusers are solid members, when the conventional diffuser is stowed, the solid diffuser will occupy the same amount of space as when the diffuser is deployed. Inasmuch as storage space in the vehicle can be limited, the storage of the diffuser in the vehicle when not deployed can take away space that can be used for other purposes.

### SUMMARY

This section provides a general summary of the disclosure, and is not a comprehensive disclosure of its full scope or all of its features.

According to a first aspect of the present disclosure there is provided a diffuser assembly configured for use on a plurality of different vehicles that each have different aerodynamic characteristics, wherein the diffuser assembly includes at least one panel configured to move between a non-deployed position and a first plurality of deployed positions; at least one first actuator device connected to the at least one panel, and configured to move the at least one panel between the non-deployed position and the first plurality of deployed positions; and a diffuser assembly controller including a memory, the diffuser assembly controller being in communication with the at least one first actuator device and configured to instruct the at least one first actuator device to move the at least one panel from the non-deployed position to each of the first plurality of deployed positions, wherein instructions corresponding to each deployed position of the first plurality of deployed positions are stored in the memory and configured to be accessed by the diffuser assembly controller to be communicated by the diffuser assembly controller to the at least one first actuator device, and the first plurality of deployed positions stored in the memory include a plurality of second deployed positions that respectively correspond to each vehicle of the plurality of different vehicles.

According to the first aspect, the diffuser assembly controller is configured to receive a communication from an electronic control unit of a vehicle of the plurality of vehicles to identify a model of the vehicle.

According to the first aspect, after receipt of the communication from the electronic control unit that identifies the model of the vehicle, the diffuser assembly controller is configured to communicate instructions to the at least one first actuator to move the panel from the non-deployed position to the second plurality of deployed positions that are associated with the identified model.

According to the first aspect, the second plurality of deployed positions are different for each vehicle of the plurality of vehicles, and are tailored to improve the aerodynamic characteristics of each vehicle.

According to the first aspect, the at least one first actuator device is configured to control a distance that the panel extends outward from the vehicle.

According to the first aspect, the diffuser assembly may also include at least one second actuator device that is configured to pivot the at least one panel about a pivot axis to adjust an angle of the at least one panel relative to a position that extends in parallel with a ground beneath the vehicle.

According to the first aspect, the plurality of second deployed positions that respectively correspond to each vehicle of the plurality of different vehicles include the distance that the panel extends outward from the vehicle and the angle of the at least one panel relative to a position that extends in parallel with a ground beneath the vehicle.

According to a second aspect of the present disclosure, there is provided a vehicle that may include a body including at least a front end and a rear end, the body defining aerodynamic characteristics of the vehicle; a vehicle electronic control unit (ECU) that contains data that identifies a model of the vehicle; a diffuser assembly connected to the body, and configured to improve the aerodynamic characteristics of the vehicle, the diffuser assembly including at least one panel configured to move between a non-deployed position and a first plurality of deployed positions that are positioned outboard from the rear end of the body; at least one first actuator device connected to the at least one panel, and configured to move the at least one panel between the non-deployed position and the first plurality of deployed positions; and a diffuser assembly controller including a memory, the diffuser assembly controller being in communication with vehicle ECU and the at least one first actuator device, the diffuser assembly controller being configured to instruct the at least one first actuator device to move the at least one panel from the non-deployed position to each of the first plurality of deployed positions, wherein instructions corresponding to each deployed position of the first plurality of deployed positions are stored in the memory and configured to be accessed by the diffuser assembly controller to be communicated by the diffuser assembly controller to the at least one first actuator device, and the first plurality of deployed positions stored in the memory include a plurality of second deployed positions that each respectively correspond to the model of the vehicle; and wherein upon receipt of a communication from the ECU by the diffuser assembly controller that identifies the model of the vehicle, the diffuser assembly controller is configured to access only the instructions in the memory that correspond to plurality of second deployed positions that each respectively correspond to the model of the vehicle.

According to the second aspect, after receipt of the communication from the vehicle ECU that identifies the model of the vehicle, the diffuser assembly controller is configured to communicate the only instructions to the at least one first actuator to move the panel from the non-deployed position to the second plurality of deployed positions that are associated with the identified model.

According to the second aspect, the first plurality of deployed positions that are stored in the memory include a plurality of deployed positions that correspond to a plurality of different vehicles.

According to the second aspect, the at least one first actuator device is configured to control a distance that the panel extends outward from the rear end of the body.

According to the second aspect, the diffuser assembly may also include at least one second actuator device that is configured to pivot the at least one panel about a pivot axis to adjust an angle of the at least one panel relative to a position that extends in parallel with a ground beneath the vehicle.

According to the second aspect, the plurality of second deployed positions that respectively correspond to the model of vehicle identified by the vehicle ECU include the distance that the panel extends outward from the rear end of the body and the angle of the at least one panel relative to a position that extends in parallel with a ground beneath the vehicle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1 and 2 are side-perspective views of example vehicles that may include a diffuser according to a principle of the present disclosure;

FIG. 3 is a schematic perspective view of a bottom of a vehicle that may include a diffuser according to a principle of the present disclosure;

FIG. 4 illustrates an example vehicle having a diffuser according to a principle of the present disclosure, in a non-deployed position; and

FIG. 5 illustrates the example vehicle having the diffuser according to a principle of the present disclosure, in a deployed position.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

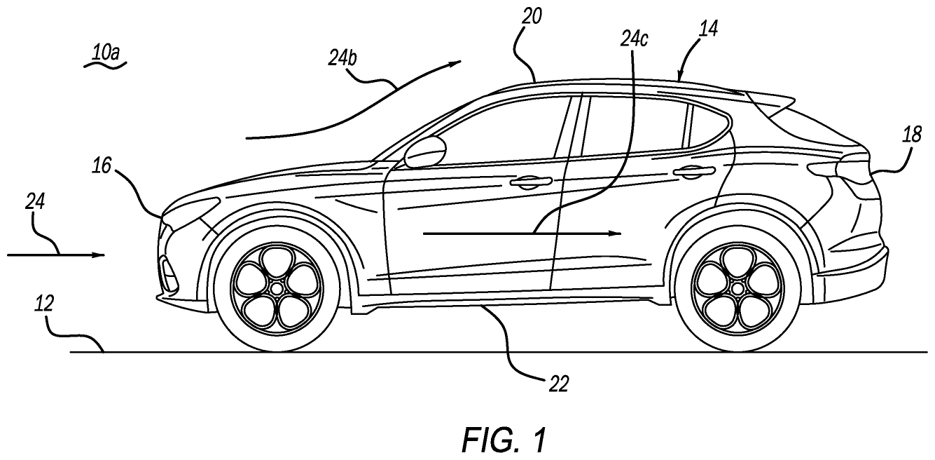

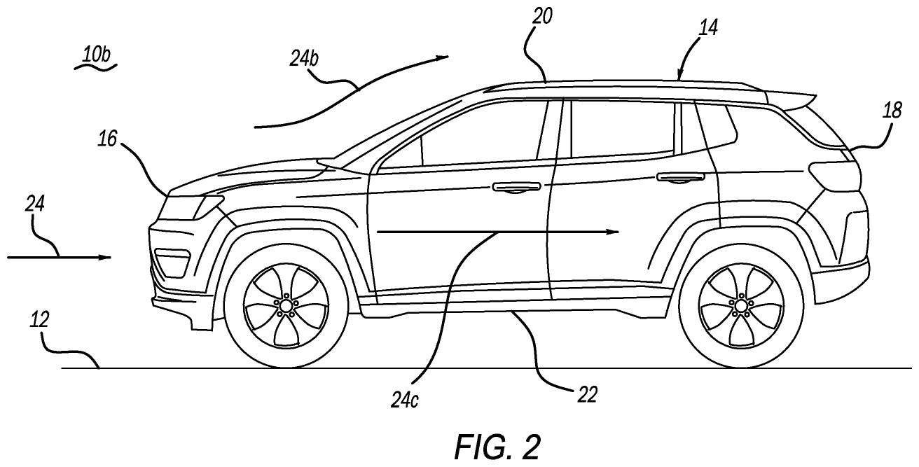

Referring now to FIGS. 1 and 2, example automotive vehicles 10a and 10b are illustrated. The vehicles 10a and 10b are positioned proximate to a road surface 12. Vehicles 10a and 10b each include a vehicle body 14 that includes a front end 16, a rear end 18, a vehicle roof 20, and an underbody portion 22 (FIG. 3). As understood by those skilled in the art, the front ends 16 are configured to face oncoming ambient airflow 24 when the vehicles 10a and 10b are in motion relative to the road surface 12.

While the present disclosure should not be limited thereto, the vehicles 10a and 10b illustrated in FIGS. 1 and 2 may be electrically powered vehicles. It should be understood, however, that the teachings of the present disclosure are equally applicable to vehicles powered by conventional internal combustion engines as well as vehicles powered by a hybrid propulsion system. Moreover, while vehicles 10a and 10b are illustrated as sport utility vehicles, it should be understood that the present disclosure is equally applicable to other types of vehicles such as a sedan, a van, a pickup truck, or any other type of vehicle known to one skilled in the art. In any event, while vehicles 10a and 10b appear to be similarly sized vehicles that have similar profiles, it should be understood that each vehicle 10a and 10b has different aerodynamic properties that can be improved using a diffuser assembly, which will be described in more detail later.

Now referring to FIG. 3, it can be seen that underbody portion 22 is illustrated as having a substantially flat surface. It will be appreciated and acknowledged by one skilled in the art, however, that underbody portion 22 may include components of various sub-systems such as, for example, a vehicle suspension (not shown), brake systems (not shown), and other features of the vehicles 10a and 10b. Nonetheless, inasmuch as there may be various skid plates and/or belly pans (not shown) beneath vehicles 10a and 10b, as the ambient air 24 flows beneath underbody portion 22 and transitions to a first airflow portion 24a the air may flow with limited disturbance.

The underbody portion 22 also defines an underbody space between the vehicle body 14 and the road surface 12. Accordingly, the underbody space permits the first airflow portion 24a to pass under the vehicle body 14, between the vehicle body 14 and the road surface 12, while a second airflow portion 24b passes over the top body portion 24. Furthermore, third and fourth airflow portions 24c and 24c pass around the left and right sides 21, 23, respectively. The airflow portions 24a-24d all rejoin behind the rear end 18 in a wake area or recirculating airflow region 26 immediately behind the rear end 18 of the moving vehicles 10a and 10b. The recirculating airflow region 26 behind vehicles 10a and 10b, due to vehicles 10a and 10b each having different aerodynamic profiles, is different for each vehicle 10a and 10b.

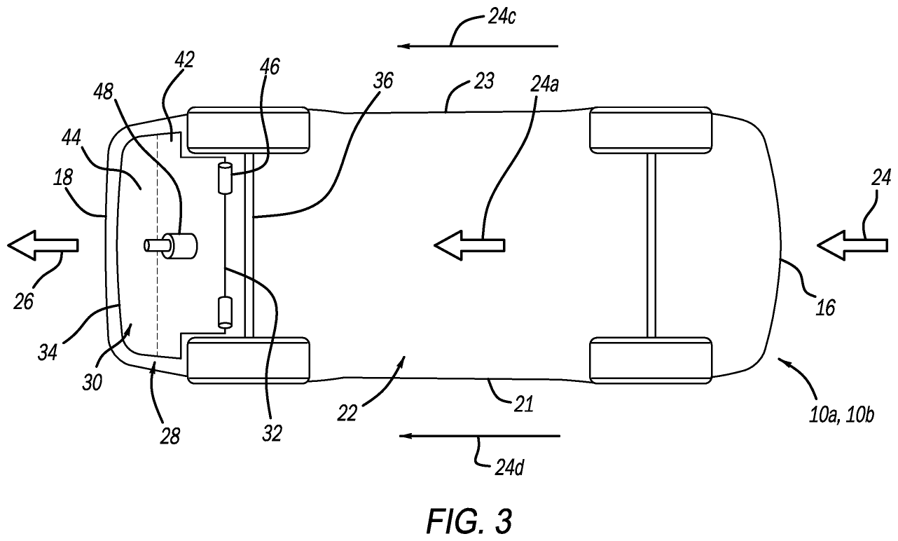

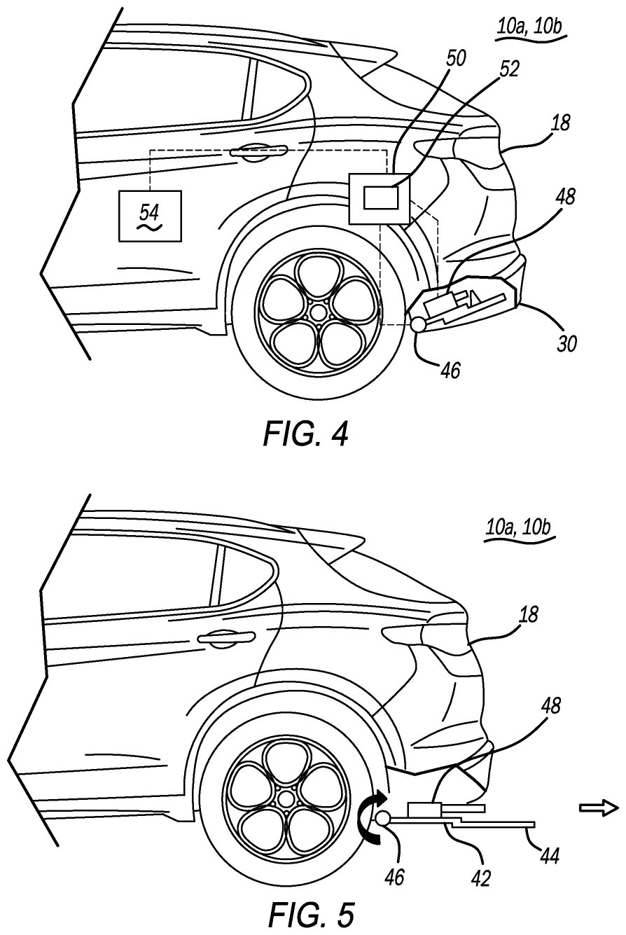

As shown in FIGS. 3-5, vehicles 10a and 10b can include an active diffuser assembly 28 disposed at the rear end 18 proximate to the underbody portion 22. The active diffuser assembly 28 is configured to control the first airflow portion 24a past the underbody portion 22 through the underbody and out to the ambient. The active diffuser assembly 28 includes a panel 30 configured to selectively extend into and retract from the recirculating airflow region 26. Panel 30 may be formed of, for example, a rigid polymeric material, a rigid metal material, or may be formed of polymeric or metal materials that are configured to flex. In any event, the retracted or stowed position is illustrated in FIGS. 3 and 4, and the extended or deployed position is illustrated in FIG. 5. The panel 30 extends from a front edge 32 to a rear edge 34. In the illustrated embodiment the front edge 32 may be disposed proximate a rear axle 36. However, in other embodiments the front edge 32 may be positioned in other locations such as, for example, further aft of the rear axle 36. In the illustrated embodiment the panel 30 extends substantially a full width of the vehicle 10a, 10b from the left side 21 to the right side 23. However, in other embodiments, the panel 30 may extend a smaller portion of the width of the vehicle 10a, 10b. In the illustrated embodiment, the panel 30 may include a first portion 42 and a second portion 44.

As shown in FIGS. 3-5, the active diffuser assembly 28 also includes a first actuator 46 configured to pivot (e.g., rotate) the panel 30 relative underbody 22 and relative to a position arranged in parallel with roadway 12, as will be described in more detail later. The panel 30 is configured to pivot about a pivot axis extending generally along and parallel with the front edge 32 (i.e., front edge 32 in the drawings may also be used to signify the pivot axis). In the embodiment illustrated in FIGS. 4 and 5, the first actuator 46 is configured as an active actuator (e.g., as a motor configured to act directly at the pivot axis, or as a linear actuator configured to act tangentially to the pivot axis). However, in other embodiments other types of actuations may be implemented, as are known in the art.

In addition, the active diffuser assembly 28 may include a second actuator 48 configured to extend the panel 30 in a fore-aft direction. The second actuator 48 may be configured as an active, linearly-extending actuator as shown in FIG. 3, which may be, for example, a fluidly actuated device, a servomotor, or a solenoid, or some other type of linear actuator device. The first actuator 46 and the second actuator 48 may each include a single actuator or a plurality of individual actuators. In embodiments where a plurality of individual actuators are used, the actuators may be located symmetrically along the rear end 18 in order to facilitate uniform extension and retraction of the panel 30 relative to both the left side 21 and the right side 23. The first actuator 46 and the second actuator 48 may be dual-action (i.e., configured to move the panel 30 from the stowed position to the deployed position and to move the panel 30 from the deployed position to the stowed position).

In a deployed position, the extended panel 30 permits the first airflow portion 24a to expand in the underbody space. However, expansion of the first airflow portion 24a by the diffuser assembly 28 while the panel 30 is extended does not cause excessive airflow separation or drag on the vehicle body 14. Rather, such extension of the panel 30 enhances the aerodynamic profile of the vehicle body 14 by providing a degree of “wake infill” (i.e., filling of the recirculating airflow region 26 immediately behind the moving vehicle 10a, 10b). Furthermore, the active diffuser assembly 28 causes the flow of the air upstream of the panel 30 to accelerate through the underbody portion 22, thus generating a downforce and an attendant drag reduction on the vehicle body 14.

The enhanced aerodynamic profile of the vehicle body 14 may provide a benefit with respect to at least one of fuel economy, battery range, and with respect to the noise level being perceived by the occupants of vehicle 10a, 10b, and additionally reduce quantities of dirt or debris collecting on the rear end 18. Additionally, the dual-action type of first actuator 46 may be configured to extend the panel 30 for a predetermined distance past the rear end 18 such that the extension of the panel 30 provides the desired aerodynamic benefit (i.e., drag reduction on the vehicle body 14).

The first actuator 46 and the second actuator 48 are in communication with a diffuser assembly controller 50 that can be used to adjust a tilt of panel 30 about the pivot axis using first actuator 46, and used to adjust a distance that the panel 30 extends outward from rear end 18 using second actuator 48. During operation of vehicles 10a and 10b, the tilt of panel 30 and the distance that panel 30 extends outward from rear end 18 can be dynamically controlled based on signals received by diffuser assembly controller 50 that are indicative of, for example, a velocity of the vehicles 10a and 10b. The signals indicative of a velocity the vehicle 10a or 10b can be received by diffuser assembly controller 50 from, for example, a vehicle electronic control unit 54.

While depicted as a single unit, the diffuser assembly controller 50 may include one or more additional controllers. The controller 50 may include a microprocessor or central processing unit (CPU) 52 in communication with various types of computer readable storage devices or media 52, hereinafter referred to as a “memory” 52. Memory 52 may include volatile and nonvolatile storage in a read-only memory (ROM), a random-access memory (RAM), and a keep-alive memory (KAM), for example. KAM is a persistent or non-volatile memory that may be used to store various operating variables while the CPU is powered down. Memory 52 may also be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the diffuser assembly controller 50 in controlling the diffuser assembly 28.

The diffuser assembly 28 that is used in vehicles 10a and 10b can be the same. That is, diffuser assembly 28 in each vehicle 10a and 10b can include the same panel 30 having the same dimensions, the same first actuator(s) 46, the same second actuator(s) 48, and the same diffuser assembly controller 50 and memory 52. In this manner, a single diffuser assembly 28 can be designed for use in a plurality of different vehicles that may have similar body styles and dimensions. By developing a single diffuser assembly 28 that can be used across a plurality of different models, research and development costs as well as manufacturing costs can be reduced. This is desirable from the standpoint that, in general, it is customary for a diffuser assembly to be designed for a specific vehicle model. Put another way, while a pair of vehicles may have similar sizes and dimensions, it has been customary for different vehicle models to have a specifically designed diffuser assembly that is specifically tailored for the aerodynamic properties of that particular vehicle model. Inasmuch as this increases the costs associated with the design and manufacture of the vehicle, this is undesirable.

Notwithstanding that the diffuser assembly 28 that is used on each vehicle 10a and 10b is the same, it should be understood that the manner in which diffuser assembly 28 is deployed on each of the different vehicles 10a and 10b is different due to the different aerodynamic characteristics of vehicles 10a and 10b. For example, it can be determined during evaluation of vehicle 10a having diffuser assembly 28 that at a velocity of 65 miles per hour (mph) panel 30 should extend outward from rear end 18 of vehicle 10a by a distance of, for example, 200 cm, and be tilted 5 degrees downward relative a horizontal position that is parallel with roadway 12 to provide the optimum amount of improvement in aerodynamic properties. Conversely, for example, it can be determined during evaluation of vehicle 10b having the same diffuser assembly 28 that at a velocity of 65 mph panel 30 should extend outward from rear end 18 of vehicle 10a by a distance of, for example, 150 cm, and be tilted 5 degrees upward relative a horizontal position that is parallel with roadway 12 to provide the optimum amount of improvement in aerodynamic properties.

The distances that panel 30 extends outward from rear end 18 and the amounts of tilt at which panel 30 is rotated relative to the pivot axis can be determined for each vehicle 10a and 10b at different velocities and stored in memory 52 of diffuser assembly controller 50. That is, the data/instructions associated with operation of diffuser assembly 28 on vehicle 10a and data/instructions associated with operation of diffuser assembly 28 on vehicle 10b are stored in memory 52. During operation of vehicles 10a and 10b at various velocities that are communicated by ECU 54 to diffuser assembly controller 50, memory 52 is then accessed by diffuser assembly controller 50 to control first and second actuators 46, 48 to deploy the panel 30 to the correct distance and orientation (tilt) to provide the optimum improvement in aerodynamic properties for the respective vehicle 10a or 10b.

Inasmuch as the same diffuser assembly controller 50 and memory 52 are used on different vehicles 10a and 10b that have different aerodynamic properties and, therefore, different deployed positions for panel 30 to yield the optimal improvement in aerodynamic properties, it is necessary that diffuser assembly controller 50 be configured to determine which vehicle 10a or 10b that diffuser assembly 28 is installed in order for the correct deployment positions of panel 30 to be utilized to optimize the aerodynamic properties of the vehicle 10a or 10b. This may be accomplished by the ECU 54 of each vehicle 10a and 10b being different, or at least by ECU 54 being programmed to identify the specific model of vehicle. In either case, upon startup of the vehicle 10a or 10b, ECU 54 may be configured to transmit a communication or instruction to diffuser assembly controller 50 that identifies the particular model of vehicle. Based on this communication from ECU 54, diffuser assembly controller 50 is then configured to access memory 52 to obtain the data/instructions for operating diffuser assembly 28 in accordance with the identified vehicle 10a or 10b.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A diffuser assembly configured for use on a plurality of different vehicles that each have different aerodynamic characteristics, the diffuser assembly comprising:
at least one panel configured to move between a non-deployed position and a first plurality of deployed positions;
at least one first actuator device connected to the at least one panel, and configured to move the at least one panel between the non-deployed position and the first plurality of deployed positions; and
a diffuser assembly controller including a memory, the diffuser assembly controller being in communication with the at least one first actuator device and configured to instruct the at least one first actuator device to move the at least one panel from the non-deployed position to each of the first plurality of deployed positions,
wherein instructions corresponding to each deployed position of the first plurality of deployed positions are stored in the memory and configured to be accessed by the diffuser assembly controller to be communicated by the diffuser assembly controller to the at least one first actuator device, and the first plurality of deployed positions stored in the memory include a plurality of second deployed positions that respectively correspond to each vehicle of the plurality of different vehicles.

2. The diffuser assembly according to claim 1, wherein the diffuser assembly controller is configured to receive a communication from an electronic control unit of a vehicle of the plurality of vehicles to identify a model of the vehicle.

3. The diffuser assembly according to claim 2, wherein after receipt of the communication from the electronic control unit that identifies the model of the vehicle, the diffuser assembly controller is configured to communicate instructions to the at least one first actuator to move the panel from the non-deployed position to the second plurality of deployed positions that are associated with the identified model.

4. The diffuser assembly according to claim 3, wherein the second plurality of deployed positions are different for each vehicle of the plurality of vehicles, and are tailored to improve the aerodynamic characteristics of each vehicle.

5. The diffuser assembly according to claim 4, wherein the at least one first actuator device is configured to control a distance that the panel extends outward from the vehicle.

6. The diffuser assembly according to claim 5, further comprising at least one second actuator device that is configured to pivot the at least one panel about a pivot axis to adjust an angle of the at least one panel relative to a position that extends in parallel with a ground beneath the vehicle.

7. The diffuser assembly according to claim 6, wherein the plurality of second deployed positions that respectively correspond to each vehicle of the plurality of different vehicles include the distance that the panel extends outward from the vehicle and the angle of the at least one panel relative to a position that extends in parallel with a ground beneath the vehicle

8. A vehicle comprising:
a body including at least a front end and a rear end, the body defining aerodynamic characteristics of the vehicle;
a vehicle electronic control unit (ECU) that contains data that identifies a model of the vehicle;
a diffuser assembly connected to the body, and configured to improve the aerodynamic characteristics of the vehicle, the diffuser assembly including:
at least one panel configured to move between a non-deployed position and a first plurality of deployed positions that are positioned outboard from the rear end of the body;
at least one first actuator device connected to the at least one panel, and configured to move the at least one panel between the non-deployed position and the first plurality of deployed positions; and
a diffuser assembly controller including a memory, the diffuser assembly controller being in communication with vehicle ECU and the at least one first actuator device, the diffuser assembly controller being configured to instruct the at least one first actuator device to move the at least one panel from the non-deployed position to each of the first plurality of deployed positions,
wherein instructions corresponding to each deployed position of the first plurality of deployed positions are stored in the memory and configured to be accessed by the diffuser assembly controller to be communicated by the diffuser assembly controller to the at least one first actuator device, and the first plurality of deployed positions stored in the memory include a plurality of second deployed positions that each respectively correspond to the model of the vehicle; and
wherein upon receipt of a communication from the ECU by the diffuser assembly controller that identifies the model of the vehicle, the diffuser assembly controller is configured to access only the instructions in the memory that correspond to plurality of second deployed positions that each respectively correspond to the model of the vehicle.

9. The vehicle according to claim 8, wherein after receipt of the communication from the vehicle ECU that identifies the model of the vehicle, the diffuser assembly controller is configured to communicate the only instructions to the at least one first actuator to move the panel from the non-deployed position to the second plurality of deployed positions that are associated with the identified model.

10. The vehicle according to claim 9, wherein the first plurality of deployed positions that are stored in the memory include a plurality of deployed positions that correspond to a plurality of different vehicles.

11. The vehicle according to claim 8, wherein the at least one first actuator device is configured to control a distance that the panel extends outward from the rear end of the body.

12. The vehicle according to claim 11, further comprising at least one second actuator device that is configured to pivot the at least one panel about a pivot axis to adjust an angle of the at least one panel relative to a position that extends in parallel with a ground beneath the vehicle.

13. The vehicle according to claim 12, wherein the plurality of second deployed positions that respectively correspond to the model of vehicle identified by the vehicle ECU include the distance that the panel extends outward from the rear end of the body and the angle of the at least one panel relative to a position that extends in parallel with a ground beneath the vehicle.
